(19) United States
(12) Patent Application Publication
(10) Pub. No.: US 2013/0229019 A1
(43) Pub. Date: Sep. 5, 2013

(54) METHOD AND DEVICE FOR OPERATING A STARTER OF A VEHICLE

(71) Applicants: Rasmus Rettig, Hamburg (DE); Werner Schiemann, Fellbach (DE)

(72) Inventors: Rasmus Rettig, Hamburg (DE); Werner Schiemann, Fellbach (DE)

(21) Appl. No.: 13/818,978

(22) PCT Filed: Jul. 14, 2011
(86) PCT No.: PCT/EP2011/062027

§ 371 Date: May 8, 2013

(30) Foreign Application Priority Data
Aug. 27, 2010 (DE) 102010039875.6

(51) Int. Cl. F02N 11/08

(52) U.S. Cl. CPC F02N 11/08
USPC 290/38 R

(57) ABSTRACT

In a method for operating a starter of a vehicle, a physical variable is measured, and a starter current of the starter is limited or not limited as a function of the measured physical variable, the limiting action being terminated after a predetermined period of time in the event that the starter current is limited.

### BACKGROUND OF THE INVENTION

1. Field of the Invention

The present invention relates to a method and a device for operating a starter of a vehicle, and furthermore relates to a control program.

2. Description of the Related Art

Methods are known for limiting electrical currents, for example in a motor vehicle or household electronics, with the aid of fuses. Fuses of this type interrupt the circuit when overcurrents occur and usually must be replaced after the cause of the overcurrent has been corrected, or they must be reactivated by a user.

However, electrical consumers exist in which very brief overcurrent peaks occur, for example during activation, and a continuous interruption of the circuit is not permitted. Examples of this are incandescent lamps, relays and electric motors. Following the current peaks described above, the supply voltage drops significantly, caused by additional series resistors, for example in a battery.

Another example of the behavior described above is a drop in a vehicle electrical system voltage of an electrical system of a vehicle during operation of a starter for starting an internal combustion engine of the vehicle. Currents of up to more than 1,000 amperes typically occur when starting the starter, which may cause the vehicle electrical system voltage to drop by several volts. Other electrical consumers are deactivated by this drop during the starting operation and must be restarted once the vehicle electrical system voltage or supply voltage is again within the permissible range.

In published European patent document EP 104 1277 B1, for example, a supply voltage of an electric motor is limited with the aid of an electrical resistor during a starting phase of the electric motor. A current in the electric motor is measured during this starting phase. Shortly after activating the motor, the current flow reaches a local maximum. This local maximum is detected, and once the current in the motor has again dropped below a predetermined value after the point in time at which the local maximum occurs, the electrical resistor is jumpered with the aid of a transistor, so that the motor is operated at the full supply voltage.

However, the disadvantage of this approach is, in particular, that a limiting action of this type is carried out even in unfavorable operating environments of the motor, for example at low temperatures and/or low supply voltages. As a result, it is possible for a starting operation of the motor to be delayed in such situations or for the motor to fail to start at all.

### BRIEF SUMMARY OF THE INVENTION

An object of the present invention is providing a method and a device for operating a starter of a vehicle which permits reliable starting of a motor even under poor environmental conditions, for example at a low temperature and/or a low supply voltage.

The present invention includes the idea of providing a method for operating a starter of a vehicle. In a first step, a physical variable is measured. In a second subsequent step, a decision is made about whether a starter current of the starter is limited or is not limited, as a function of the measured physical variable. For example, if the measured physical variable is less than or greater than or less than/equal to or greater than/equal to a predetermined value, the starter current of the starter is not limited. It may also be preferably provided that the aforementioned conditions result in the starter current of the starter not being limited. In particular, it may also be provided that a starter current of the starter is limited or is not limited if the measured physical variable is not within a predetermined range or if it is within a predetermined range.

If it was determined in the preceding step that the starter current of the starter is to be limited, the limiting of the starter current in this case is terminated after a predetermined period of time. In particular, the predetermined period of time may be set or determined on the basis of the previously measured physical variable or the previously measured physical variables. The predetermined period of time may therefore be dependent on the measured physical variable.

The method provides the advantage, in particular, that the real operating environments of the vehicle during the starting operation or when starting up an engine are taken into account. In particular, if operating conditions that are poor or unfavorable for a starting operation prevail, the starter current is not limited, so that the starter may be operated at the full supply voltage. According to the related art, a limiting action is always active during the starting operation, regardless of the real operating environments.

The method furthermore provides the advantage, in particular, that, if the starter current is limited, the starter may be operated again at the full supply voltage after a predetermined period of time, based on the termination of the limiting of the starter current after the predetermined period of time, so that a maximum starting torque is available for starting the motor.

The present invention furthermore includes the idea of providing a device for operating a starter of a vehicle. According to the present invention, the device includes a limiter for limiting a starter current and a jumper for electrically jumpering the limiter, so that the starter current is not limited during jumpering. The device furthermore includes a control unit for switching the jumper to a jumpering or a non-jumpering mode. When the jumper is switched to the jumpering mode, the jumper jumpers the limiter, so that the starter current is not limited. If the jumper is switched to the non-jumpering mode, the jumper does not jumper the limiter. The starter current is therefore limited. The control unit preferably includes one or more metal oxide semiconductor field effect transistors (MOSFET), in particular power MOSFETs and/or one or multiple activating circuit(s), in particular activating integrated circuits (activating ICs).

According to the present invention, the control unit is furthermore designed for switching the jumper to the jumpering or the non-jumpering mode as a function of a measured physical variable. The control unit is furthermore designed for terminating the jumpering mode after a predetermined period of time.

The advantages described in connection with the method apply similarly to the device.

The device preferably includes three connections or pins for connecting the device to a starter circuit of the vehicle. For example, the first connection or pin is connectable to an electrical energy source. In particular, the electrical energy source includes one or multiple batteries and/or one or multiple capacitors. In particular, the electrical energy source provides an electrical energy, in particular an electrical voltage, for the starter of the vehicle. For example, the second connection may be connected to a starter relay or to the starter. The third connection or pin is preferably connected to ground or grounded. This advantageously makes it possible to install the device in an existing starter circuit of a vehicle. Cost-effective retrofitting is thus enabled. Due to the three connections, the device may also be referred to as a three-pin device. Due to the ability to install the device directly into the starter circuit, it may also be independently and autonomously operated in the starter circuit. In particular, additional external control units are not needed, which advantageously saves money and reduces weight. If it is necessary to communicate with other control units in the vehicle, this may be accomplished, for example, with the aid of another connection.

According to one preferred specific embodiment, the physical variable is a temperature and/or an electrical variable. The electrical variable is preferably an electrical voltage and/or an electrical current. In particular, the electrical voltage or the electrical current may be a supply voltage or a supply current of the electrical energy source. In particular, the temperature is an ambient temperature and/or an engine compartment temperature of the vehicle. This advantageously makes it possible to adapt a starting operation of the starter to the corresponding real environmental conditions of the vehicle. For example, if the temperature is less than 0° C., the starter current is preferably not limited. At a temperature above 0° C., for example, starter current limiting may occur, in particular if the supply voltage is between 7 V and 12 V. The starter current is preferably limited within a supply voltage range of 7 V to 12 V. Furthermore, it may be preferably provided that the starter current is limited even at a supply voltage greater than 12 V, regardless of the temperature, since the high supply voltage permits a reliable starting operation of the starter in this case. The starter current is preferably not limited at a supply voltage of less than 7 V, regardless of the temperature. This advantageously makes it possible to reliably start the engine even at a low supply voltage.

A detector for detecting the physical variable is preferably provided. In particular, the detector includes a voltage detector and/or a current detector. In particular, the detector includes one or multiple temperature sensors. For example, it may be provided that the detector is integrated into the control unit. It may also be preferably provided that the detector is situated outside the control unit and, in particular, is connected to the control unit for transmitting a corresponding detector signal. In particular, the integration of the detector into the control unit provides the advantage of a particularly compact configuration of the device. If the detector is provided outside the control unit, the detector may be advantageously replaced particularly easily and economically.

According to another exemplary specific embodiment, a drop in another electrical variable in an electrical starter circuit is detected, a detection point in time of the drop corresponding to a starting point in time of a predetermined period of time. This means that, for example, a voltage drop is detected at the limiter. The predetermined period of time in which the starter current is limited begins to elapse, starting at the point in time when the voltage dropping at the limiter falls below a predetermined threshold value. A timer for generating a time signal is preferably provided for this purpose. In particular, the timer is integrated into the control unit but may also be situated, for example, outside the control unit. For example, once the voltage drop at the limiter falls below the predetermined threshold value, the control unit activates the timer. The timer then outputs a time signal to the control unit after a predetermined period of time, whereby the control unit then switches the jumper from the jumpering mode to the non-jumpering mode so that the limiting of the starter current is terminated after the predetermined period of time.

According to another specific embodiment, the starter current is limited with the aid of a resistor. In particular, the limiter includes one or multiple electrical resistors. The limiter preferably includes a variably adjustable resistor, for example a potentiometer. This advantageously makes it possible to adapt a starter current limiting action to different starters for different vehicles.

The limiting of the starter current is preferably terminated by a transistor, in particular a power transistor, which is electrically connected in parallel to the resistor, jumpering the resistor. The transistor is preferably a field effect transistor (FET) or a metal oxide semiconductor field effect transistor (MOSFET). This particularly advantageously enables a particularly fast switching to be achieved between the jumpering mode to the non-jumpering mode and vice versa.

The device is preferably used to limit an electrical current in one or multiple electrical loads. An electrical load may include, for example, an electric motor and/or a starter.

The present invention furthermore includes the idea of providing a control program which includes program code for carrying out the method when the control program is run on the control unit.

The present invention is explained in greater detail below on the basis of preferred exemplary embodiments with reference to the drawings.

### BRIEF DESCRIPTION OF THE DRAWINGS

FIG. 1 shows a time curve of a vehicle electrical system voltage and a starter current.

FIG. 2 shows a device for operating a starter of a vehicle.

FIG. 3 shows a detailed view of the device from FIG. 2.

FIG. 4 shows another device for operating a starter of a vehicle.

FIG. 5 shows a graph which indicates the operating conditions under which the starter current may be limited, for example.

FIG. 6 shows a time curve of multiple electrical variables and operating states of individual components of the device from FIG. 3.

FIG. 7 shows a time curve of a vehicle electrical system voltage and a starter current when the starter is operated with the aid of the method according to the present invention.

FIG. 8 shows a schematic flow chart of a method for operating a starter of a vehicle.

### DETAILED DESCRIPTION OF THE INVENTION

The same reference numerals are used below for the same features.

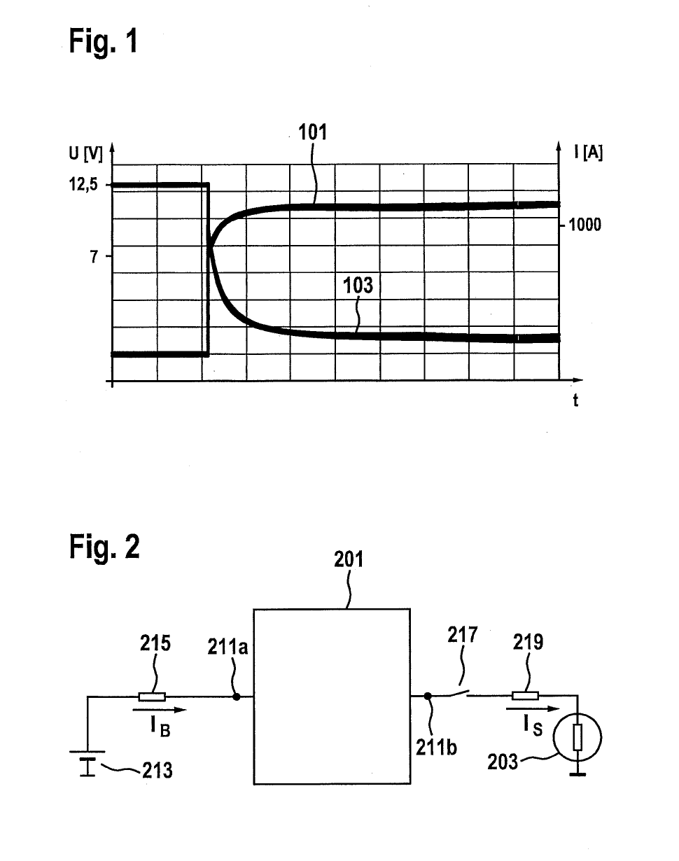

FIG. 1 shows a time curve of a vehicle electrical system voltage and a starter current. Time t is plotted on the abscissa in random units. Vehicle electrical system voltage U is plotted in volts on the left ordinate. Starter current I is plotted in amperes on the right ordinate. The time curve of the vehicle electrical system voltage is identified by reference numeral 101. The time curve of the starter current is identified by reference numeral 103. It is apparent that the starter current rises to approximately 1,000 A when the starter is activated. At the same time, the vehicle electrical system voltage drops from approximately 12.5 V to approximately 7 V. Due to this voltage drop, electrical consumers of the vehicle electrical system, in particular, are deactivated during the starting operation and must be restarted once the vehicle electrical system voltage is again within the permissible range.

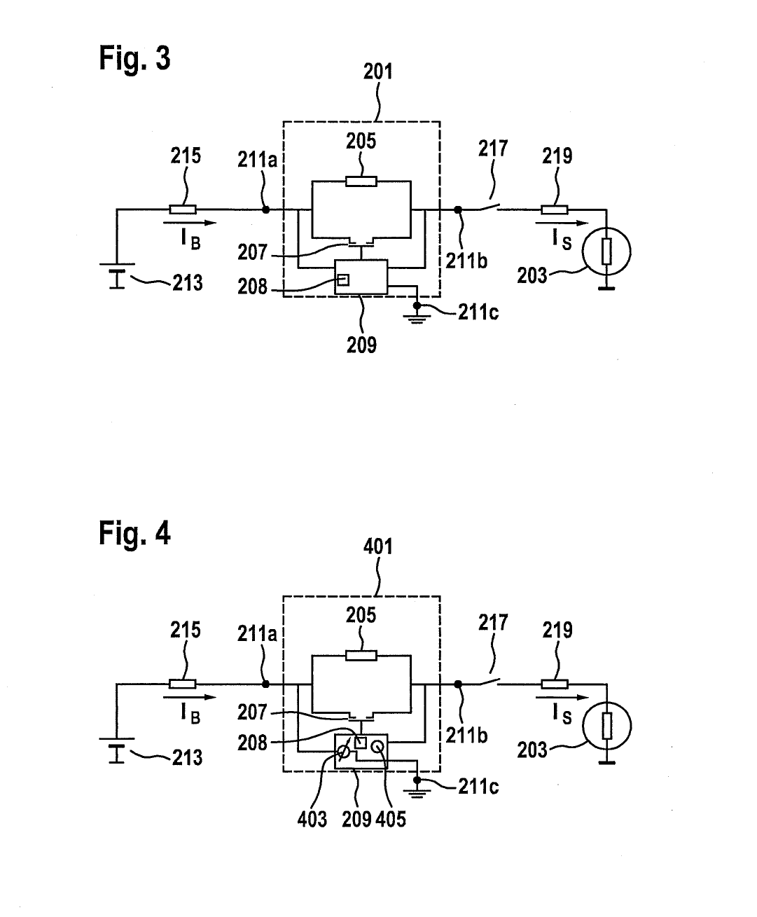

It is possible, in particular, to limit the voltage drop illustrated in FIG. 1 with the aid of device 201 illustrated in FIGS. 2 and 3 for operating a starter 203 of a vehicle (not illustrated). FIG. 3 shows a detailed view of device 201. Device 201 has an electrical resistor 205. A transistor 207 is connected in parallel to resistor 205. In addition, device 201 includes a control unit 209, which is electrically connected to the circuit formed by resistor 205 and transistor 207. Device 201 also has three connections 211a, 211b and 211c. Connections 211a, 211b and 211c may also be referred to as pins. Device 201 is connected to a battery 213 with the aid of connection 211a. An inductor 215 is furthermore provided between battery 213 and connection 211A. Device 201 is connected to starter 203 with the aid of connection 211b. A starter relay 217 and another inductor 219 are also connected in series between starter 203 and connection 211b. Device 201 is connected to ground with the aid of third connection 211c. It is advantageously possible, in particular, to use device 201 in an existing starter circuit without a great deal of complexity with the aid of the three connections or pins 211a, 211b, 211c. Cost-effective retrofitting is thus enabled. Due to the presence of the three pins 211a, 211b, 211c, device 201 may also be referred to as a three-pin device.

In the exemplary embodiment illustrated in FIGS. 2 and 3, electrical resistor 205 forms a limiter for limiting a starter current. Transistor 207 forms a jumper for electrically jumpering the limiter, so that the starter current is not limited during a jumpering. Control unit 209 itself may switch, in particular, transistor 207 to a jumpering mode or to a non-jumpering mode.

A timer 208 for generating a time signal is furthermore integrated into control unit 209. Timer 208 is activated, in particular, when starter 203 is started and a limiting of the starter current occurs. After a predetermined period of time, timer 208 then generates a time signal to which control unit 209 responds in that control unit 209 switches transistor 207 to the jumpering mode.

When starter relay 217 is closed, for example because a user has issued a start request, a battery current I_{B} flows which is provided with the aid of battery 213. If transistor 207 is in the non-jumpering mode, battery current I_{B} flows through electrical resistor 205, through starter relay 217 and the other inductor 219 to starter 203. Downstream from connection 211b, the correspondingly flowing electrical current may also be referred to as starter current I_{S}. If transistor 207 is in the jumpering mode, battery current I_{B} flows via transistor 207 to starter 203. In this case, starter current I_{S} is therefore not limited.

FIG. 4 shows a detailed view of another preferred specific embodiment of a device 401 for operating starter 203 of a vehicle. A voltage detector 403 and a temperature sensor 405 are furthermore integrated into control unit 209 of device 401. Voltage detector 403 measures, in particular, battery voltage 213. Temperature sensor 405 measures, in particular, an ambient temperature and/or an engine compartment temperature of the vehicle. These two measured physical variables are included, in particular, in the decision of whether the starter current of the starter is limited or is not limited. Control unit 209 then switches transistor 207 to either the jumpering mode or the non-jumpering mode as a function of this decision.

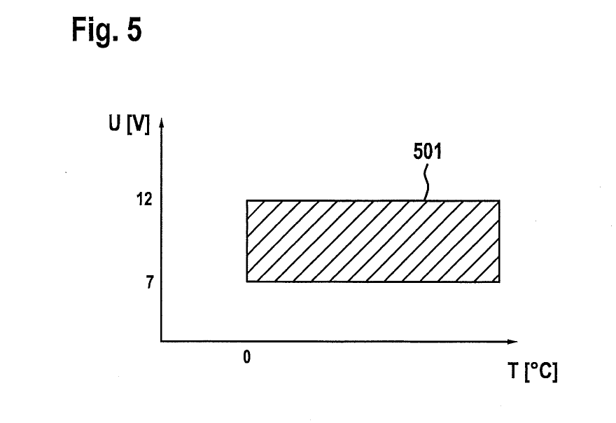

FIG. 5 shows a graph which schematically identifies the ranges within which the starter current is limited directly upon starting the starter during the starting operation. Battery voltage U, for example of battery 213, is plotted in volts on the ordinate, the battery voltage also possibly being referred to as a supply voltage. Ambient temperature T of the vehicle is plotted in Celsius on the abscissa. If both the supply voltage and the ambient temperature are located in hatched area 501, a starter current of starter 203 is initially limited during a starting operation, the limiting action then being cancelled, in particular, at a later point in time. Hatched area 501 includes ambient temperatures of greater than or equal to 0° C. and voltage values between 7 V and 12 V, 7 V and 12 V still being within hatched area 501. If the supply voltage and/or the ambient temperature is/are located outside hatched area 501, starter current I_{S} is not limited directly upon starting starter 203, for example in that transistor 207 is switched to the jumpering mode. Electrical resistor 205 is therefore jumpered. The real operating parameters of the vehicle may thus be advantageously taken into account in the decision relating to an initial starter current limiting action. A supply voltage of greater than 12 V is thus a sign of a sufficiently charged battery, which is also able to provide a sufficiently high supply voltage for electrical consumers of a vehicle electrical system even when current peaks occur. The case of an old or weak battery having a supply voltage of less than 7 V is also taken into account, provided that no starter current limiting is carried out, since the limited current would otherwise no longer be sufficient, for example, to reliably start the starter, or since a starting operation of the starter would otherwise be substantially prolonged.

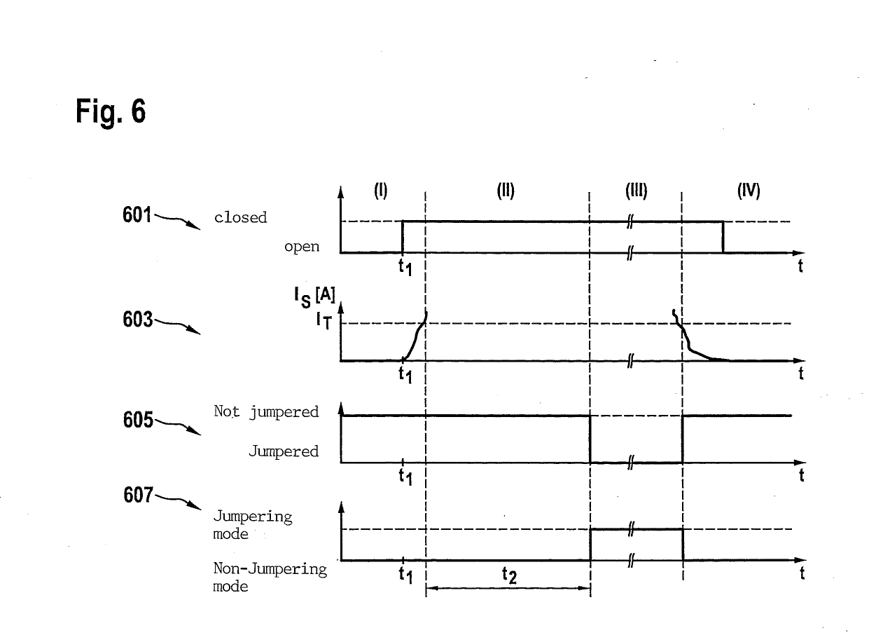

FIG. 6 shows the time curve of a number of physical variables and a number of operating states of components of the starter circuit during a starting operation. The upper graph having reference numeral 601 shows the state of starter relay 217 over a time t. Starting relay 217 may be switched back and forth between an open state and a closed state.

The graph having reference numeral 603 shows the time curve of starter current I_{S}.

The graph having reference numeral 605 indicates when resistor 205 is jumpered or not jumpered.

The graph having reference number 607 indicates when transistor 207 is in a non-jumpering mode, i.e., when transistor 207 is open, or when it is in a jumpering mode, i.e., when transistor 207 is closed.

Resistor 205 is not jumpered in a phase I. Starter relay 217 is closed at a point in time t₁. Since resistor 205 is not jumpered, starter current I_{S} is limited. Transistor 207 is therefore in the non-jumpering mode.

A current in the supply line generates a voltage drop at electrical resistor 205. If this voltage drop reaches a threshold I_{T}, timer 208 is activated and a phase II begins. Starter current I_{S} continues to be limited during phase II, i.e., during time period t_{S}. After a predetermined time period t_{S}, timer 208 outputs a time signal, after which control unit 209 switches transistor 207 to the jumpering mode (see phase III). Resistor 205 is thus jumpered by transistor 207. As a result, starter current I_{S} is not further limited.

Starter current I_{S} again falls below threshold I_{T} at the transition to phase IV. Control unit 209 switches transistor 207 back to the non-jumpering mode. Device 401 returns, so to speak, to its idle state.

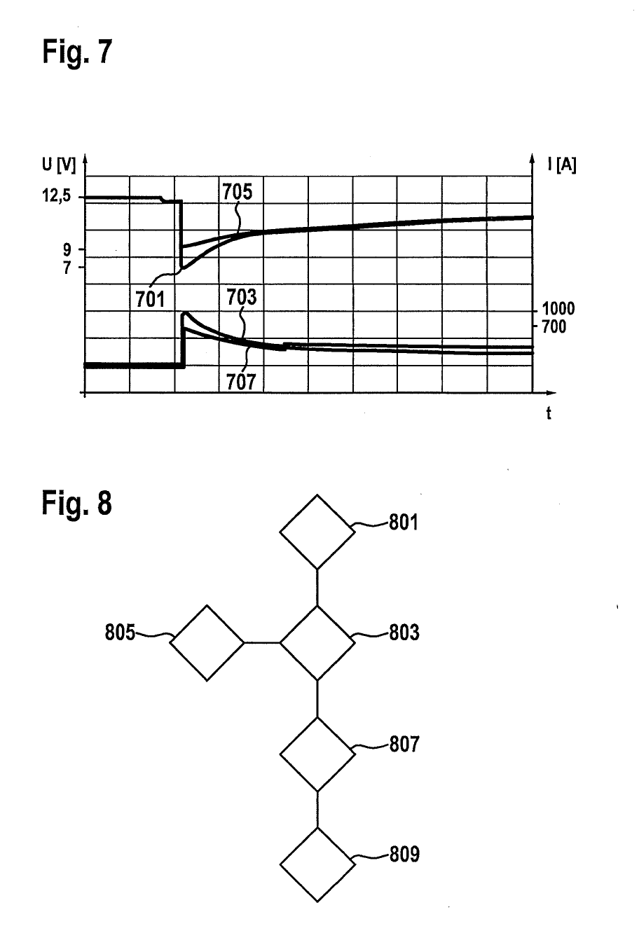

FIG. 7 shows a time curve of the vehicle electrical system voltage and the starter current in a known starting device without current limiting and in device 201 or 401. The abscissa shows time t in random units. Vehicle electrical system voltage U is plotted as V on the left ordinate. Starter current I is plotted as A on the right ordinate. The vehicle electrical system voltage in the known starting device without current limiting is identified by reference numeral 701. The time curve of the corresponding starter current is identified by reference numeral 703. The time curve of a vehicle electrical system voltage in device 201 or 401 according to the present invention is identified by reference numeral 705. The time curve of the starter current in device 201 or 401 according to the present invention is identified by reference numeral 707. It is clearly apparent that the starter current is limited to approximately 700 A, due to device 201 or 401 according to the present invention, so that a voltage drop of the vehicle electrical system voltage is limited at approximately 9 V instead of dropping to approximately 7 V according to the related art.

FIG. 8 shows a flow chart of one specific embodiment of a method for operating a starter of a vehicle. In a step 801, a physical variable is measured. For example, the physical variable may be an ambient temperature of the vehicle and/or a battery supply voltage. In a step 803, a decision is then made as to whether a starter current of the starter is limited or not limited as a function of the physical variable measured in step 801. If it is decided in step 803 that a starter current is not limited, for example, control unit 209 switches transistor 207 to the jumpering mode in a step 805. If it is decided in step 803 that the starter current is limited, the starter current is limited in a step 807, in particular by transistor 207 being switched to the non-jumpering mode. At the end of a predetermined period of time, the limiting of the starter current is terminated in a step 809, in particular by control unit 209 switching transistor 207 to the jumpering mode so that transistor 207 electrically jumpers resistor 205. As a result, the starter current is not further limited.

The present invention furthermore provides, in particular, the following advantages:
Device 201 or 401 may operate independently and autonomously in a supply line of an electrical load. No interfaces to other control units are needed.
This minimizes, in particular, manufacturing costs.
In particular, this also advantageously makes it possible to install the device in existing starter circuits.
In particular, a full supply voltage is available for starting the engine of the vehicle in limiting ranges, for example at a low supply voltage or at a low temperature.
In addition to the drop in supply voltage, electromagnetic interferences, which may occur due to the pulsing of the current in a supply line, is minimized. This makes it furthermore advantageously possible to reduce measures for stabilizing, for example, the vehicle electrical system. Backup batteries, backup capacitors or downstream DC/DC converters are superfluous. This furthermore advantageously results in reduced weight and lower costs.
In particular, this increases the service life of the electric machine, for example the starter, by reducing torques which occur during startup.
The electric machine may be manufactured more easily and more cheaply. For example, wall thicknesses may be reduced. This makes it possible to advantageously achieve additional weight reductions and cost savings.
A voltage supply, for example with the aid of the starter battery in the motor vehicle, is preserved. Its service life is increased.
Noise and vibrations are reduced and, in particular, this also increases comfort.
   The starting operation is improved. For example, it is possible to advantageously shorten the starting time of an internal combustion engine started by the electric machine.
The device described herein minimizes, in particular, costs, installation space and weight.
It also provides the ability to implement a highly integrated approach which works autonomously on the starter and which may be used as a favorable retrofit approach.
The bias current intake by the device is reduced to nearly zero, even though the device is continuously supplied with current, in particular due to the configuration based on the three-pin connections, the device being activated or started by a voltage passing over the integrated resistor.

According to the present invention, the device may also be used to limit current in electrical loads. According to the present invention, in particular, a method and a device for limiting a starting current of an electrical load is provided, the initial current corresponding to the starter current in the case of a starter.

1-15. (canceled)

16. A method for operating a starter of a vehicle, comprising:
measuring a physical variable;
performing an initial selective switching, as a function of the measured physical variable, to a limiting operating mode in which a starter current of the starter is limited; and
terminating the limiting of the starter current after a predetermined period of time;
wherein a subsequent selective switching to the limiting operating mode is performed as a function of the starter current dropping below a specified threshold value after the termination of the limiting action following the initial selective switching.

17. The method as recited in claim 16, wherein the starter current is not limited if the measured physical variable is one of less than or equal to a predetermined value.

18. The method as recited in claim 17, wherein the physical variable is a supply voltage of the vehicle, and wherein the starter current is not limited if the supply voltage is less than 7 volts.

19. The method as recited in claim 16, wherein the physical variable is one of a temperature or an electrical variable.

20. The method as recited in claim 18, further comprising:
detecting a second electrical variable in the starter circuit, wherein a point in time at which the second electrical variable reaches a predetermined threshold corresponds to a starting point in time of the predetermined period of time.

21. The method as recited in claim 20, wherein the starter current is limited with the aid of a resistor.

22. The method as recited in claim 21, wherein the resistor is electrically connected in parallel to a transistor, and wherein the limiting of the starter current is terminated by jumpering the resistor using the transistor.

23. A device for operating a starter of a vehicle, comprising:
a limiter for limiting a starter current;
a jumper for selectively electrically jumpering the limiter, wherein the starter current is not limited during jumpering;
a control unit for selectively switching the jumper between a jumpering mode and a non-jumpering mode as a function of a measured physical variable, wherein the control unit is configured to: (i) perform an initial selective switching, as a function of the measured physical variable, to the non-jumpering mode to achieve a limiting mode in which a starter current of the starter is limited; (ii) terminate the limiting of the starter current after a predetermined period of time by switching to the jumpering mode; and (iii) perform a subsequent selective switching to the non jumpering mode to achieve the limiting mode as a function of the starter current dropping below a specified threshold value after the termination of the limiting action following the initial selective switching.

24. The device as recited in claim 23, wherein the control unit does not limit the starter current if the measured physical variable is one of less than or equal to a predetermined value.

25. The device as recited in claim 24, wherein the control unit detects a supply voltage of the vehicle as the physical variable, and wherein the starter current is not limited if the supply voltage is less than 7 volts.

26. The device as recited in claim 23, wherein the limiter and the jumper are electrically connected in parallel.

27. The device as recited in claim 26, wherein at least one of (i) the limiter includes an electrical resistor, and (ii) the jumper includes a transistor.

28. The device as recited in claim 25, further comprising:
a detector for detecting the physical variable.

29. The device as recited in claim 25, further comprising:
a timer for generating a time signal for the predetermined period of time.

30. A non-transitory computer-readable data storage medium storing a computer program having program codes which, when executed on a computer, performs a method for operating a starter of a vehicle, the method comprising:
measuring a physical variable;
performing an initial selective switching, as a function of the measured physical variable, to a limiting operating mode in which a starter current of the starter is limited; and
terminating the limiting of the starter current after a predetermined period of time;
wherein a subsequent selective switching to the limiting operating mode is performed as a function of the starter current dropping below a specified threshold value after the termination of the limiting action following the initial selective switching.
